(19) United States
(12) Patent Application Publication
(10) Pub. No.: US 2025/0189785 A1
(43) Pub. Date: Jun. 12, 2025

(54) HEAD-UP DISPLAY APPARATUS

(71) Applicant: Maxell, Ltd., Kyoto (JP)

(72) Inventor: Tomoki YAMAMOTO, Kyoto (JP)

(73) Assignee: Maxell, Ltd., Kyoto (JP)

(21) Appl. No.: 18/875,177

(22) PCT Filed: Mar. 24, 2023
(86) PCT No.: PCT/JP2023/012022

§ 371 Date: Dec. 16, 2024

(30) Foreign Application Priority Data
Jun. 28, 2022 (JP) 2022-103330

(51) Int. Cl. G02B 27/01; B60K 35/233

(52) U.S. Cl. CPC G02B 27/0101; B60K 35/233; G02B 27/0149; G02B 2027/0161; G02B 2027/0185

(57) ABSTRACT

A head-up display apparatus that includes an image forming unit that emits video light; an optical element provided in the image forming unit and that generates video light divided into a first video light and a second video light as the video light; a first returning mirror that reflects the first video light; a second returning mirror that reflects the second video light; and a video projector that reflects the first video light from the first returning mirror and the second video light from the second returning mirror, and a first display region which is a first display area capable of displaying a first virtual image is formed based on the first video light from the video projector, and a second display region which is a second display area capable of displaying a second virtual image is formed based on the second video light from the video projector.

### TECHNICAL FIELD

The present invention relates to a technique for a head-up display (HUD) apparatus.

### BACKGROUND ART

As a HUD apparatus installed in vehicles and the like, a HUD apparatus configured to form a plurality of virtual images on a front side relative to a transparent member such as a windshield or a combiner (dedicated display panel) when viewed from a driver's viewpoint has been developed.

Japanese Unexamined Patent Application Publication No. 2016-14861 (Patent Document 1) is presented as an example of a prior-art technique. Patent Document 1 describes “to provide a heads-up display device capable of efficiently orienting image light toward a viewer with a simple configuration.” and “The projection unit 10 emits the projection light 200a depicting a display image, the first reflection unit 21 reflects the projection light 200a exiting the projection unit 10 towards the second reflection unit 24, the second reflection unit 24 reflects the projection light 200a reflected by the first reflection unit 21 towards the transmissive screen 30, and the transmissive screen 30 outputs the image light 100 obtained by transmitting and scattering the projection light 200a reflected by the second reflection unit 24 towards an observer. By adjusting the angle of the light axis of the projection light 200a entering the transmissive screen 30 by rotating the first reflection unit 21 and the second reflection unit 24, the angle of the image light 100 exiting the transmissive screen 30 is adjusted.”

### RELATED ART DOCUMENTS

### Patent Documents

Patent Document 1: Japanese Unexamined Patent Application Publication No. 2016-14861

### SUMMARY OF THE INVENTION

### Problems to be Solved by the Invention

In the HUD apparatus in the conventional technique such as Patent Document 1, the direction of the video light is changed by rotating the mirror, whereby it is possible to provide the virtual image in accordance with the height position of the viewpoint of the driver (observer).

An object of this disclosure is to provide a technique capable of favorably forming a plurality of display regions that can display virtual images, in relation to the technique of the HUD apparatus described above. The display region is, in other words, the display region, display area, and screen of the HUD.

### Means for Solving the Problems

A typical embodiment of this disclosure has the following configuration. A head-up display apparatus according to the embodiment includes: a picture generation unit configured to emit video light, an optical element provided in the picture generation unit and configured to generate video light divided into a first video light and a second video light as the video light, a first returning mirror configured to reflect the first video light, a second returning mirror configured to reflect the second video light, and a video projector configured to reflect the first video light from the first returning mirror and the second video light from the second returning mirror, a first display region which is a first display area capable of displaying a first virtual image is formed based on the first video light from the video projector, and a second display region which is a second display area capable of displaying a second virtual image is formed based on the second video light from the video projector.

### Effect of the Invention

According to the typical embodiment of this disclosure, it is possible to favorably form a plurality of display regions that can display virtual images, in relation to the technique of the HUD apparatus described above. The problems, configurations, effects, and the like other than those described above will be described in the following embodiments.

### BRIEF DESCRIPTIONS OF THE DRAWINGS

FIG. 1 illustrates a configuration example of a vehicle in which a HUD apparatus according to a first embodiment is installed.

FIG. 2 illustrates a configuration example of the installed HUD apparatus and others in the vehicle in FIG. 1.

FIG. 3 illustrates a configuration example of a video display unit and others in the HUD apparatus according to the first embodiment.

FIG. 4 illustrates a configuration example of a picture generation unit in the HUD apparatus according to the first embodiment.

FIG. 5 illustrates a first configuration example of two display regions viewed from a driver's viewpoint in the HUD apparatus according to the first embodiment.

FIG. 6 illustrates a second configuration example of the two display regions viewed from the driver's viewpoint in the HUD apparatus according to the first embodiment.

FIG. 7 illustrates a schematic explanatory diagram related to an optical path blocking function and others in the HUD apparatus according to the first embodiment.

FIG. 8 illustrates a mounting configuration example of a mirror, a dust cover, and others of the video display unit in the HUD apparatus according to the first embodiment.

FIG. 9 illustrates a schematic diagram related to a temperature detection for the optical path blocking function in the HUD apparatus according to the first embodiment.

FIG. 10 illustrates a configuration example of sensors and others for acquiring vehicle information in the HUD apparatus according to the first embodiment.

FIG. 11 illustrates a configuration example of functional blocks in the HUD apparatus according to the first embodiment.

FIG. 12 illustrates a mounting configuration example of the picture generation unit in the HUD apparatus according to the first embodiment.

FIG. 13 illustrates a configuration example of a video display unit and others in a HUD apparatus according to a second embodiment.

FIG. 14 illustrates a configuration example of a video display unit and others in a HUD apparatus according to a modification 1A of the first embodiment.

FIG. 15 illustrates a configuration example of a video display unit and others in a HUD apparatus according to a modification 1B of the first embodiment.

FIG. 16 illustrates a configuration example of a video display unit and others in a HUD apparatus according to a modification 1C of the first embodiment.

FIG. 17 illustrates a schematic explanatory diagram related to an optical path blocking function and others in a HUD apparatus according to a modification 1D of the first embodiment.

FIG. 18 illustrates a third configuration example of the two display regions viewed from the driver's viewpoint in the HUD apparatus according to the first embodiment.

FIG. 19 illustrates a fourth configuration example of the two display regions viewed from the driver's viewpoint in the HUD apparatus according to the first embodiment.

### DETAILED DESCRIPTION OF PREFERRED EMBODIMENTS

Hereinafter, embodiments of this disclosure will be described in detail with reference to the drawings. In all the drawings for describing the embodiments, the same members are denoted by the same reference characters in principle, and the repetitive description thereof will be omitted. The components depicted in the drawings may have different positions, sizes, ranges, and others from those of the actual ones in order to make the invention easily understood.

When describing the processing by a program, the program, function, processing unit, and others may be described as main subjects in some cases for convenience of description, but the main subject as the hardware for these is a processor or a controller, device, computer, system, and others configured by the processor and the like. The computer executes the processing according to the program, which is read into the memory, by the processor, while using resources such as a memory and a communication interface as appropriate. In this way, predetermined functions, processing units, and others are realized. The processor is composed of, for example, a semiconductor device such as a CPU/MPU or a GPU. The processing can be implemented not only by software program processing, but also by dedicated circuits. An FPGA, ASIC, CPLD, and the like can be applied as the dedicated circuit.

The program may be installed in advance as data in the target computer, or may be distributed as data from a program source to the target computer. The program source may be a program distribution server on a communication network or a non-transitory computer-readable storage medium such as a memory card or disk. The program may be made up of a plurality of modules. The computer system may be made up of a plurality of devices. The computer system may be configured as a client-server system, a cloud computing system, an IoT system, or the like. The various kinds of data and information are configured in structures such as tables and lists, but are not limited thereto. Expressions such as identification information, identifier, ID, name, number, and the like are interchangeable.

### Solutions etc.

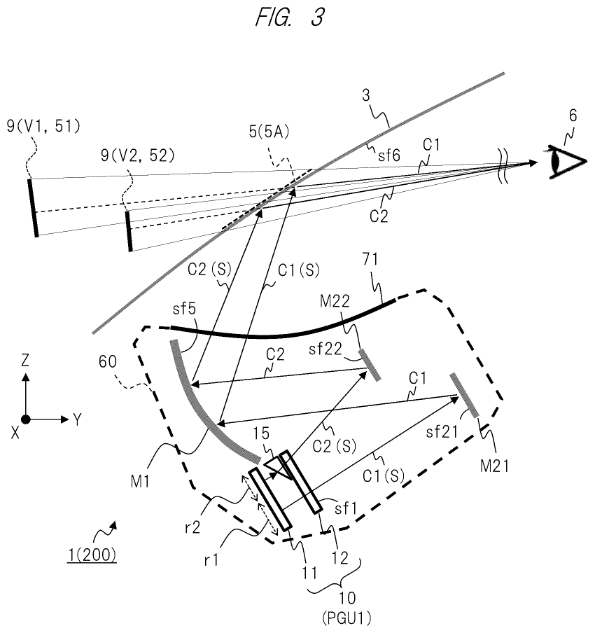

The basic purpose and function of the HUD apparatus according to the embodiment are to be able to form two virtual images corresponding to two display regions on a front side relative to the windshield when viewed from the driver's viewpoint. In order to realize such a configuration, in the HUD apparatus according to the embodiment, the configuration of the optical system including a picture generation unit or an image forming unit, mirrors, and others is devised. Specifically, as illustrated in FIG. 3 and others, a picture generation unit PGU1 which is a video display device, two returning mirrors M21 and M22, and a concave mirror M1 are provided in a video display unit 200 of a HUD apparatus 1.

The picture generation unit PGU1 includes a light source and a display panel, and between the light source and the display panel, the display surface is divided into two predetermined regions of a first region r1 and a second region r2, an optical element 15 is disposed in the second region r2, and the optical element 15 is not disposed in the first region r1. In this way, the picture generation unit PGU1 emits a first video light C1 from the corresponding first region r1 of the display panel based on the light passing through the first region r1, and emits a second video light C2 from the corresponding second region r2 of the display panel based on the light passing through the optical element 15 in the second region r2.

Furthermore, in the HUD apparatus according to the embodiment, the video light C1 and the video light C2 from the picture generation unit PGU1 are reflected by the two mirrors M21 and M22, which are returning mirrors, respectively. The mirror M21 reflects the video light C1, and the mirror M22 reflects the video light C2.

Then, a video projector M1 reflects the video light C1 and the video light C2 from the two mirrors M21 and M22 toward a windshield 3. The video projector M1 of the present invention is a concave mirror. In this way, two HUD display regions 5 (51, 52) corresponding to the two video lights C1 and C2 from the picture generation unit PGU1 are formed. When viewed from a driver's viewpoint 6, a first virtual image V1 is formed in the first display region 51 and a second virtual image V2 is formed in the second display region 52 on a front side relative to the windshield 3.

For example, when viewed from the driver's viewpoint 6, the first virtual image V1 of the first display region 51 is formed at a relatively distant and upper position relative to the second virtual image V2 of the second display region 52 and the second virtual image V2 of the second display region 52 is formed at a relatively close and lower position relative to the first virtual image V1 of the first display region 51. In order to design such a virtual image optical system and virtual image distance, the HUD apparatus according to the embodiment is designed such that an optical path of the first video light C1 has a longer optical distance than that of the second video light C2 inside a housing.

Specifically, the video display unit 200 reflects and returns the first video light C1 generated by passing through the first region r1 of the picture generation unit PGU1 by the mirror M21 located farther away, and reflects and returns the second video light C2 generated by passing through the optical element 15 in the second region r2 of the picture generation unit PGU1 by the mirror M21 located closer. Moreover, in order to make the video light C1 and the video light C2 separately enter the two mirrors M21 and M22, the picture generation unit PGU1 uses the optical element 15 in the second region r2 to make the emission direction of the second video light C2 different from the emission direction of the first video light C1.

In addition, optical adjustment for the optical distance, the projection direction, and others of the two video lights C1 and C2 is performed by the optical element 15 in the second region r2 in the picture generation unit PGU1. With the above-described configuration, in the HUD apparatus according to the embodiment, the optical path of the first video light C1 has a longer optical distance than that of the optical path of the second video light C2.

### FIRST EMBODIMENT

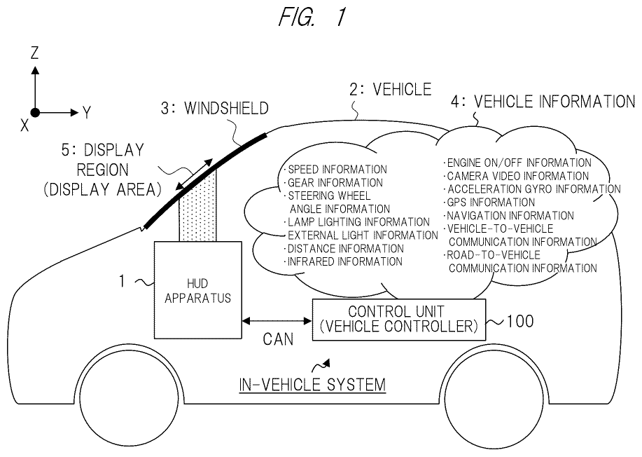

A HUD apparatus 1 according to the first embodiment will be described with reference to FIG. 1 to FIG. 12 and others. The HUD apparatus 1 according to the first embodiment is a HUD apparatus installed in a vehicle, and is an AR-HUD capable of displaying virtual images by AR.

### Vehicle

FIG. 1 illustrates a general configuration of a vehicle 2 in which the HUD apparatus 1 according to the first embodiment is installed. The vehicle 2 is provided with a control unit 100 which is a vehicle controller. The control unit 100 controls the running of the vehicle 2 and the like. The HUD apparatus 1 communicates with the control unit 100 through an interface such as CAN or LIN. The control unit 100 and the HUD apparatus 1 constitute an in-vehicle system of the vehicle 2. The HUD apparatus 1 generates video light and projects it onto a transparent region of the windshield 3. In this way, a display region 5 which is a display area is formed in the transparent region of the windshield 3, and a virtual image is displayed within the display region 5.

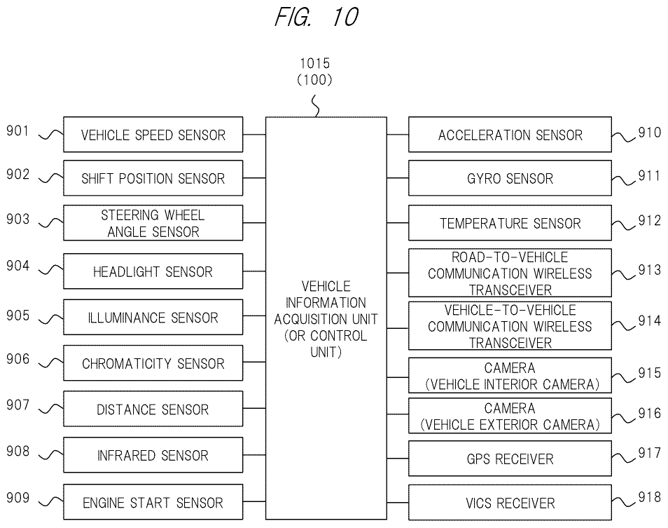

The control unit 100 can display video information as a virtual image in the display region 5 by controlling the HUD apparatus 1 through a CAN signal or the like. The control unit 100 acquires vehicle information 4 using various sensors, measuring devices, communication devices, and the like illustrated in FIG. 10 described below. The HUD apparatus 1 receives and acquires the vehicle information 4 and the like from the control unit 100 through the CAN signal or the like. The HUD apparatus 1 generates video data based on the vehicle information 4 and the like, and displays a virtual image in the display region 5 by emitting the video light.

In FIG. 1 and others, (X, Y, Z) are used as the coordinate system and directions for convenience of description. FIG. 1 and others illustrate a spatial coordinate system for the vehicle 2. The Z axis and the Z direction indicate the vertical direction, in other words, the up-down direction and the longitudinal direction. The X axis and the X direction indicate a first horizontal direction, in other words, the left-right direction and the lateral direction. The Y axis and the Y direction indicate a second horizontal direction perpendicular to the X axis, in other words, the front-rear direction.

### Video Display Unit

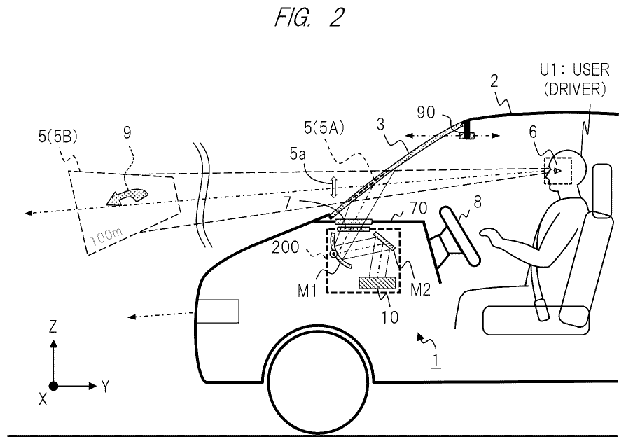

FIG. 2 illustrates an installation example of the HUD apparatus 1 according to the first embodiment in the vehicle 2 in FIG. 1. FIG. 2 is a schematic diagram illustrating the vehicle 2 in FIG. 1 on the Y-Z plane as viewed in the X-axis direction. In FIG. 2, the HUD apparatus 1, in particular, the video display unit 200 thereof is installed in a dashboard 70 of the vehicle 2. FIG. 2 illustrates a case in which a driver U1 as a user U1 is seated in the driver's seat of the vehicle 2 and visually recognizes a virtual image 9 in the display region 5 on a front side through the windshield 3. The video display unit 200 of the HUD apparatus 1 includes a video display device 10, a mirror M2, and a concave mirror M1. An optical system including the video display device 10, the mirror M2, the concave mirror M1, and others is disposed and fixed in a housing in a predetermined positional relationship.

Note that FIG. 2 illustrates the basic configuration, and does not illustrate the mirrors and two display regions illustrated in FIG. 3 described below. Instead, it illustrates them collectively as the video display device 10 which is a single picture generation unit and the single display region 5, and details thereof will be described later.

An opening disposed to match an opening 7 of the dashboard 70 is formed in a part of the housing. A transparent member such as a dust cover 71 (FIG. 3) described later is provided on the opening. The video light of the HUD apparatus 1 is emitted through the dust cover 71 or the like at the opening.

The video display device 10 forms an image on a display surface and emits video light. The mirror M2 is, for example, a plane mirror that serves as a returning mirror. The mirror M2 reflects the video light from the video display device 10 toward the concave mirror M1. The mirror M1 is a concave mirror, and functions as a video projector that magnifies and reflects the video light from the mirror M2 in a direction at a set angle. The concave mirror M1 is configured of, for example, a free-form surface mirror or a mirror having a shape asymmetrical with respect to an optical axis. The concave mirror M1 is configured of a mirror having a concave reflection surface on the X axis and the Z axis.

As illustrated in the drawing, the video light from the video display device 10 is reflected by the mirror M2 and the concave mirror M1, and the reflected video light is emitted through the opening 7 and projected onto the surface of the windshield 3. The video light is reflected by the surface of the windshield 3 and travels toward the driver's viewpoint 6. Therefore, when looking forward (rearward on the Y axis) from the driver's viewpoint 6, the display region 5 of the HUD is formed on the windshield 3, and the virtual image 9 can be visually recognized in the display region 5. In the display region 5, the virtual image 9 formed by the video light is displayed so as to be superimposed on the actual scenery on the front side. In addition, in FIG. 2, a first display region 5A along the surface of the windshield 3 and a second display region 5B formed on a front side relative to the windshield 3 are illustrated as the display region 5, and these correspond to each other.

In the case of AR (Augmented Reality), the virtual image 9 is video information that is superimposed and displayed in accordance with the position of the target object. In the case of non-AR, the virtual image 9 is video information that is displayed independently at a predetermined position. Examples of the video information to be the virtual image 9 include various kinds of information such as vehicle speed information, navigation information, and alert information.

The vehicle 2 is also provided with a camera 90, for example, near the rearview mirror. The camera 90 may be a vehicle exterior camera for taking images outside the vehicle or a vehicle interior camera for taking images inside the vehicle.

### HUD Apparatus

FIG. 3 is a schematic explanatory diagram illustrating the configuration of the video display unit 200 and the configuration of the display region 5 on the Y-Z plane as the configuration of the HUD apparatus 1 according to the first embodiment. As illustrated in FIG. 3, one of the features of the first embodiment is that one picture generation unit PGU1 including the optical element 15, the two returning mirrors M21 and M22, and the one concave mirror M1 are provided. Further, this HUD apparatus 1 generates two video lights C1 and C2 by one picture generation unit PGU1 using the optical element 15 to emit them in respective directions, reflects these two video lights C1 and C2 by the two mirrors M21 and M22, and then reflects them by the common concave mirror M1. In this way, the two display regions 5 (51, 52) are formed.

The video display unit 200 includes, in a housing 60, the picture generation unit PGU1 as the one picture generation unit. In other words, the picture generation unit PGU1 is the video display device 10. The picture generation unit PGU1 includes a light source device 11 and a liquid crystal display panel (LCD) 12 as an example of a display panel which is a display device disposed at a latter stage of the light source device 11, in other words, on the emission side thereof. Between the light source device 11 and the LCD 12, the optical element 15 is disposed in the second region r2, and the optical element 15 is not disposed in the first region r1.

The mirror M1 and the mirrors M21 and M22 in FIG. 3 correspond to the mirror M1 and the mirror M2 in FIG. 2. The mirrors M21 and M22 are disposed at a position on the front side in the Y-axis direction (rear side of the vehicle or driver's side), and the mirror M1 is disposed at a position on the rear side in the Y-axis direction (front side of the vehicle). The mirror M21 is a first returning mirror, and the mirror M22 is a second returning mirror. In the first embodiment, the two mirrors M21 and M22 are plane mirrors. The mirror M21 has a reflection surface sf21, and the mirror M22 has a reflection surface sf22. The mirror M1 is a concave mirror and has a concave reflection surface sf5.

In FIG. 3, the picture generation unit PGU1 emits the first video light C1 from the first region r1 and emits the second video light C2 from the second region r2. The picture generation unit PGU1 is disposed at a predetermined position on the front side of the vehicle in the Y-axis direction and on the lower side in the Z-axis direction relative to the mirrors M21 and M22 such that the first video light Cl and the second video light C2 are reflected by the mirrors M21 and M22.

The optical adjustment for the projection direction and others is performed by the function of the optical element 15 on the first video light C1 and the second video light C2 emitted from the display surface sf1 of the picture generation unit PGU1, so that the first video light C1 enters and is reflected by the surface sf21 of the mirror M21 and the second video light C2 enters and is reflected by the surface sf22 of the mirror M22.

The first video light C1 reflected from the mirror M21 and the second video light C2 reflected from the mirror M22 travel toward the mirror M1. The mirror M1 reflects the first video light C1 and the second video light C2 on one reflection surface sf5. As will be described later, the regions on the reflection surface sf5 that are irradiated with the first video light C1 and the second video light C2 may be different from each other. The first video light C1 and the second video light C2 after being reflected by the reflection surface sf5 of the mirror M1 each pass through the dust cover 71 disposed to match the opening, and are projected onto a surface sf6 of the windshield 3.

The video light C1 and the video light C2 are reflected by the surface sf6 of the windshield 3 and travel toward the driver's viewpoint 6. When looking forward from the viewpoint 6, the first display region 51 is formed by the first video light C1 from the picture generation unit PGU1, and the second display region 52 is formed by the second video light C2. When looking forward from the viewpoint 6, the first virtual image V1 in the first display region 51 formed by the first video light C1 and the second virtual image V2 in the second display region 52 formed by the second video light C2 can be visually recognized as the virtual image 9 in the display region 5 with respect to the windshield 3.

In the picture generation unit PGU1, the optical element 15 is disposed, in particular, at a predetermined position close to the back side of the LCD 12 (or the incidence side of the video light of the LCD 12) in the second region r2 between the light source device 11 and the LCD 12. In the picture generation unit PGU1, the light source device 11, the optical element 15, and the LCD 12 are fixed in a p predetermined positional relationship. The optical element 15 is composed of a prism or a lens.

The HUD apparatus 1 according to the first embodiment has an optical system in which one mirror M1 is shared by the first video light C1 and the second video light C2. Therefore, in the HUD apparatus 1, the optical adjustment is performed using the optical element 15 of the picture generation unit PGU1 and the two mirrors M21 and M22. The optical adjustment is an adjustment related to the optical distance, the direction, the magnification rate, and the like of the virtual image 9.

Note that various configurations related to the arrangement of the optical element 15 of the picture generation unit PGU1 are possible other than the configuration example of FIG. 3. As a modification, the optical element 15 may be disposed on the optical path posterior to the display surface sf1 of the LCD 12 which is a display panel.

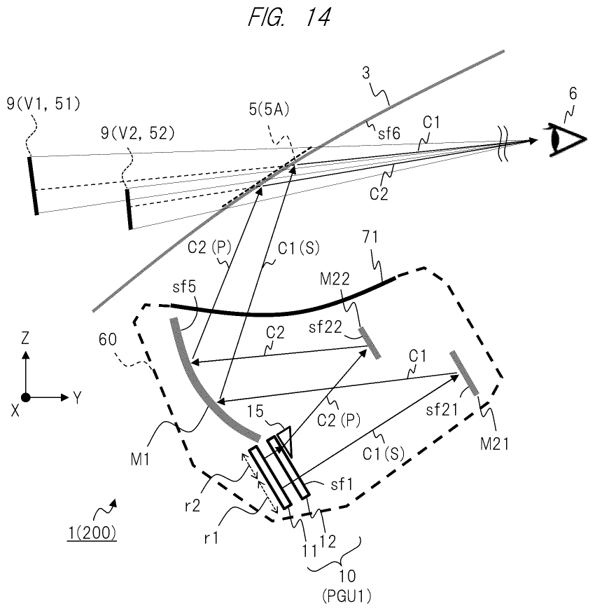

FIG. 14 illustrates a Y-Z plane in a modification 1A as a modification of the first embodiment. In FIG. 14, the optical element 15 is disposed near the display surface sf1 of the LCD 12 in the second region r2 of the picture generation unit PGU1.

As the design and the optical adjustment for the optical distance and others in the first display region 51 formed by the first video light C1 and the second display region 52 formed by the second video light C2, various configuration examples are possible using the optical element 15 and other lenses, etc. As a basic idea, the configuration in which a virtual image optical system is designed based on one optical path of the optical path of the first video light C1 and the optical path of the second video light C2 and the optical adjustment is performed on the other optical path using the optical element 15 and other lenses, etc. is possible. In the example in FIG. 3, based on the optical path of the first video light C1, the optical element 15 is not provided in the first region r1 and the optical element 15 is provided in the second region r2, whereby the optical adjustment for the optical distance and direction of the optical path of the second video light C2 is performed.

As a modification of the first embodiment, lenses for optical adjustment or the like may be disposed on the optical paths from the display surface sf1 of the picture generation unit PGU1 to the mirrors M21 and M22 as other additional components.

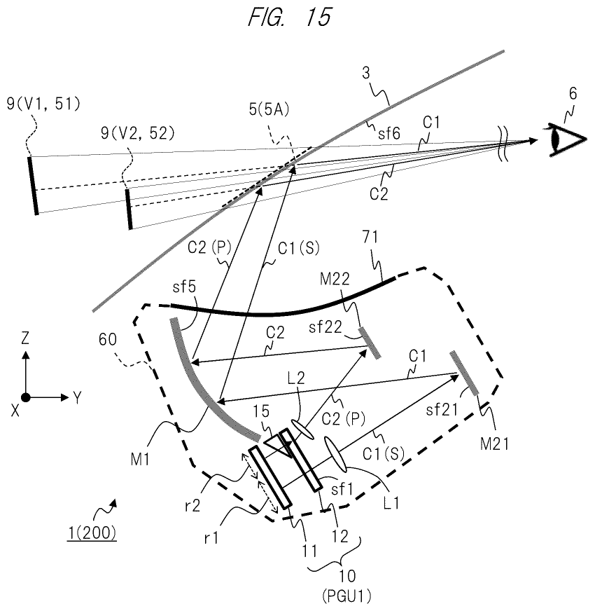

FIG. 15 illustrates a Y-Z plane in a modification 1B as a modification of the first embodiment. In FIG. 15, on the optical paths to the mirrors M21 and M22 posterior to the display surface sf1 of the picture generation unit PGU1 similar to that in FIG. 3, a first lens L1 is disposed on the optical path of the first video light C1 in the first region r1, and a second lens L2 is disposed on the optical path of the second video light C2 in the second region r2. In this way, lenses or the like for optical adjustment may be provided on both the optical path of the first video light C1 and the optical path of the second video light C2.

In this modification 1B, first, the optical adjustment for the direction and the like of the two video lights C1 and C2 is performed by the optical element 15, and the optical adjustment is further performed also by the lenses L1 and L2 at the subsequent stage. The optical adjustments by the lenses L1 and L2 include the adjustment of the optical distance and the like. In addition, in this modification 1B, the directions of the two video lights C1 and C2 are adjusted by the optical element 15 such that they spread toward the two mirrors M21 and M22 as in the first embodiment, which makes it easy to dispose the two lenses L1 and L2.

In another modification, the optical distance and others may be designed based on the optical path of one video light (for example, video light C1) of the first video light C1 and the second video light C2 and a lens or the like for optical adjustment (for example, lens L2) may be provided only on the optical path of the other video light (for example, video light C2).

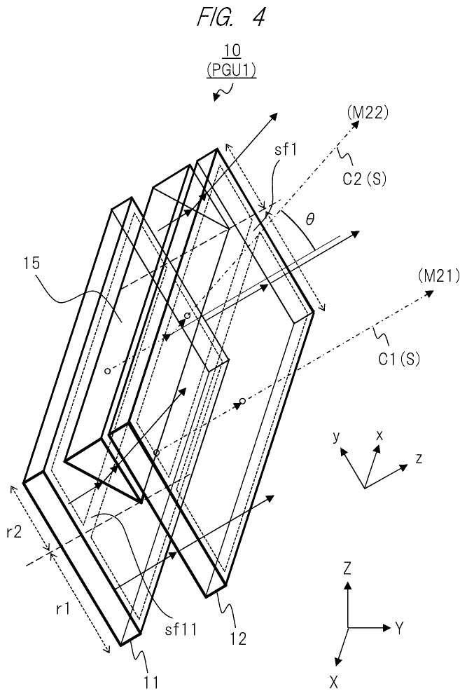

In the HUD apparatus 1 according to the first embodiment, as illustrated in FIG. 3 and FIG. 4 described later, the effective area of the display surface sf1 of the LCD 12 is divided into two regions of the first region r1 and the second region r2. The virtual image V1 of the first display region 51 is formed by the first video light C1 from the first region r1, and the virtual image V2 of the second display region 52 is formed by the second video light C2 from the second region r2. The second virtual image V2 of the second display region 52 based on the second video light C2 has a shorter virtual image distance than the first virtual image V1 of the first display region 51 based on the first video light C1. The optical path of the second video light C2 for the second display region 52 is separated from that of the first video light C1 by bending a light ray angle of the source light from the light source device 11 by the optical element 15 disposed near the back side of the LCD 12.

When the optical element 15 is configured of a lens instead of a prism, the lens is disposed at a position decentered from the optical axis of the second video light C2.

The first video light C1 and the second video light C2 are reflected by the mirror M21 and the mirror M22 which are different returning mirrors. The positions, orientations, and others of the mirror M21 and the mirror M22 are designed so as to reflect the first video light C1 and the second video light C2 toward the single shared concave mirror M1.

In the HUD apparatus 1 according to the first embodiment, the optical system is designed such that the optical path of the second video light C2 for forming the virtual image V2 in the second display region 52 has the shorter optical path length and the shorter virtual image distance than the optical path of the first video light C1 for forming the virtual image V1 in the first display region 51.

In FIG. 3, as an example of the design of the two display regions 5 (51, 52) based on the virtual image optical system, the first display region 51 is formed on the rear side in the Y-axis direction (front side of the vehicle) relative to the second display region 52, and the first display region 51 is formed on the upper side in the Z-axis direction relative to the second display region 52. The optical path and optical distance of the first video light C1 from the first region r1 of the picture generation unit PGU1 are longer than the optical path and optical distance of the second video light C2 from the second region r2 of the picture generation unit PGU1 due to the configuration of being returned by the mirror M21 and others. Therefore, the first display region 51 is formed on the rear side in the Y-axis direction (front side of the vehicle) relative to the second display region 52. Further, the irradiation position of the first video light C1 onto the mirror M1 is configured to be lower in the Z-axis direction than the irradiation position of the second video light C2 onto the mirror M1. Therefore, the first video light C1 projected from the mirror M1 onto the windshield 3 is located on the upper side relative to the second video light C2. As a result, the first display region 51 is formed on the upper side relative to the second display region 52 in the Z-axis direction.

As illustrated in FIG. 3, the HUD apparatus 1 according to the first embodiment can form the layered display region 5 including the two display regions 51 and 52, and can display the virtual images 9 (V1, V2) in the two display regions 51 and 52, respectively. The HUD apparatus 1 according to the first embodiment may display the virtual image V1 only in the first display region 51 or may display the virtual image V2 only in the second display region 52, or may display the virtual images V1 and V2 simultaneously in both the display regions 51 and 52 as appropriate.

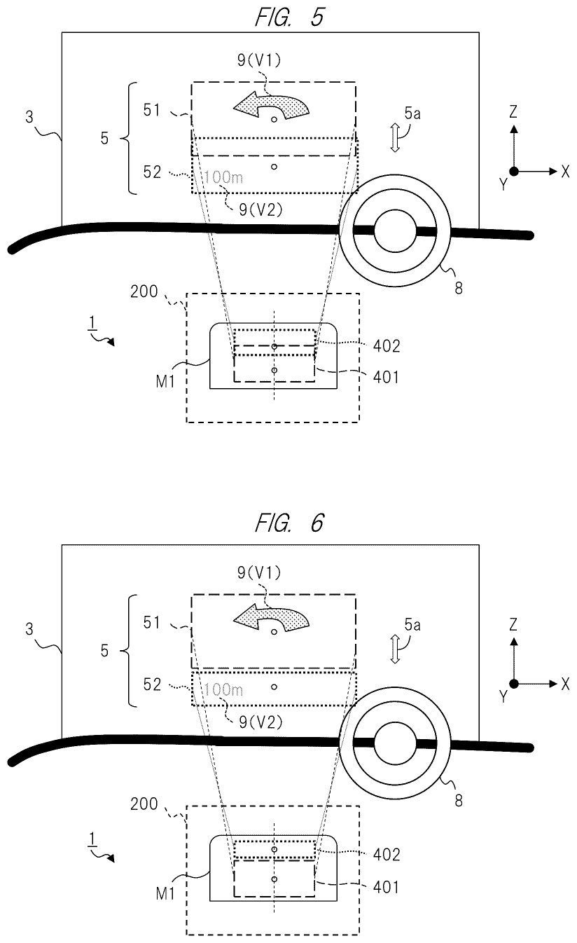

In the design example of the display region 5 and the virtual image optical system in FIG. 3, the first display region 51 and the second display region 52 are disposed so as to partially overlap in the up-down direction corresponding to the Z axis when viewed from the viewpoint 6 (FIG. 5 described below). In other words, when viewed from the viewpoint 6, a part of the first display region 51 on the lower side overlaps a part of the second display region 52 on the upper side. Besides that, the first display region 51 and the second display region 52 may be disposed so as to be separated in the up-down direction corresponding to the Z axis when viewed from the viewpoint 6 (see FIG. 6 described later).

Such a positional relationship of the virtual images 9 of the two display regions 5 can be realized by adjusting the design of the optical system, for example, by adjusting the shape, position, and orientation of the optical element 15 of the picture generation unit PGU1 and the positions and orientations of the two mirrors M21 and M22.

### Polarization Design

In the HUD apparatus 1 according to the first embodiment in FIG. 3, a design example of the polarization characteristics for the first video light C1 and the second video light C2 projected onto the surface sf6 of the windshield 3 is as follows. The first video light C1 is defined as light that enters the surface sf6 of the windshield 3 as S-polarized light (also referred to as first polarized light). The second video light C2 is defined as light that similarly enters the surface sf6 of the windshield 3 as the S-polarized light (first polarized light). In the drawings, S-polarized light may be indicated by(S) and P-polarized light may be indicated by (P) in some cases. S-polarized light (or S-wave) is the light in which the electric field vibrates in a direction perpendicular to the plane of incidence, and S stands for senkrecht. P-polarized light (or P-wave) is the light in which the electric field vibrates within the plane of incidence, and P stands for parallel. The first polarized light and the second polarized light are linearly polarized lights that are orthogonal to each other.

In accordance with this design, the picture generation unit PGU1 is a video display device that generates and emits the first video light C1 that is S-polarized light and the second video light C2 that is S-polarized light.

The following modification is also possible. That is, in the first video light C1 and the second video light C2 from the picture generation unit PGU1, the vibration direction characteristics, that is, the characteristics of S-polarized light and P-polarized light may be reversed. In this case, the virtual image V1 in the first display region 51 and the virtual image V2 in the second display region 52 are formed by P-polarized video light.

### Picture Generation Unit

FIG. 4 illustrates a perspective view of a configuration example of the picture generation unit PGU1 including the optical element 15 in FIG. 3. FIG. 4 also illustrates a coordinate system (x, y, z) based on the display surface sf1 of the LCD 12 of the picture generation unit PGU1 in addition to the spatial coordinate system (X, Y, Z). The x-axis direction is the horizontal direction (in other words, the lateral direction) within the screen on the display surface sf1, the y-axis direction is the vertical direction (in other words, the longitudinal direction) within the screen on the display surface sf1, and the z-axis direction is the direction perpendicular to the x-y plane formed by them.

In the space connecting the x-y plane on the emission side of the light source device 11 and the x-y plane on the incidence side of the LCD 12, the space is divided into two regions by the dashed line in the drawing as a boundary, and these regions will be referred to as the first region r1 and the second region r2 for convenience of description. The first region r1 and the second region r2 on the x-y plane on the emission side of the light source device 11 are each illustrated as dashed rectangles, and the first region r1 and the second region r2 on the display surface sf1, which is the x-y plane on the emission side of the LCD 12, are each illustrated as dashed rectangles.

The optical element 15 is disposed in the second region r2 in the space connecting the x-y plane on the emission side of the light source device 11 and the x-y plane on the incidence side of the LCD 12. In this example, the optical element 15 is configured of a prism having a substantially triangular prism shape as illustrated in the drawing. The axis of the triangular prism shape of the optical element 15 is disposed along the x-axis direction so as to correspond to the lateral side of the LCD 12. The cross section (y-z plane) of the triangular prism shape of the optical element 15 has, for example, a substantially right-angled triangle as illustrated in the drawing. In this right-angled triangle, one side forming a right angle is disposed adjacent to the x-y plane on the back side of the LCD 12, and an inclined side not forming the right angle is disposed so as to face an emission surface sf11 of the light source device 11.

The light source device 11 emits source light from the emission surface sf11 in the z-axis direction. The source light in the first region r1 of the light source device 11 enters the back side of the LCD 12 without passing through the optical element 15 along the optical axis indicated by one dashed-dotted arrow. The LCD 12 uses the source light in the first region r1 as backlight to emit the first video light C1 based on the image displayed in the first region r1 on the display surface sf1. On the other hand, the source light in the second region r2 of the light source device 11 passes through the optical element 15 and enters the back side of the LCD 12 along the optical axis indicated by the other dashed-dotted arrow. The LCD 12 uses the source light in the second region r2 as backlight to emit the second video light C2 based on the image displayed in the second region r2 on the display surface sf1.

The first video light C1 emitted from the first region r1 on the display surface sf1 has an optical axis along the z-axis direction. The second video light C2 emitted from the second region r2 on the display surface sf1 has an optical axis that is inclined upward at a predetermined angle θ with respect to the z-axis direction. As a result, the first video light C1 and the second video light C2 travel along the optical paths that split and spread toward the two mirrors M21 and M22.

Note that a diffusion plate or the like may be further provided in the space posterior to the light source device 11 and anterior to the position of the optical element 15.

### Display Region of HUD

FIG. 5 corresponds to FIG. 3 and illustrates a schematic configuration of the display region 5 (51, 52) on the X-Z plane formed on the windshield 3 by the video display unit 200 of the HUD apparatus 1 according to the first embodiment when looking forward (in the Y-axis direction) from the driver's viewpoint 6. FIG. 5 schematically illustrates the case where the two display regions 51 and 52 are formed by the video lights (the video lights C1 and C2 described above) reflected and projected from the concave mirror M1 onto the windshield 3. FIG. 5 particularly illustrates the case where the two display regions 51 and 52 are formed so as to partially overlap each other in the up-down direction (Z-axis direction) when viewed from the viewpoint 6.

In the effective area of the reflection surface sf5 of the concave mirror M1, a part on the lower side has a region 401 where the first video light C1 from the mirror M21 is irradiated, and a part on the upper side has a region 402 where the second video light C2 from the mirror M22 is irradiated. The first display region 51 is formed on the upper side by the first video light C1 reflected from the region 401, and the second display region 52 is formed on the lower side by the second video light C2 reflected from the region 402.

In the configuration example of FIG. 5, in the effective area of the reflection surface sf5 of the concave mirror M1, the region 401 where the first video light C1 is reflected and the region 402 where the second video light C2 is reflected partially overlap each other. As illustrated in FIG. 3, since there is an inversion relationship of images through the mirrors M1, M21, M22, and others, the virtual image V1 of the upper first display region 51 is formed by the first video light C1 from the lower region 401 on the reflection surface sf5 of the mirror M1, and the virtual image V2 of the lower second display region 52 is formed by the second video light C2 from the upper region 402.

FIG. 6 illustrates a modification related to the formation of the display region 5, in particular, the case where the two display regions 51 and 52 are formed so as to be separated in the up-down direction (Z-axis direction) without overlapping when viewed from the viewpoint 6. In the effective area of the reflection surface sf5 of the concave mirror M1, a part on the lower side has the region 401 where the first video light C1 is irradiated, and a part on the upper side has the region 402 where the second video light C2 is irradiated. The first display region 51 is formed by the first video light C1 from the region 401, and the second display region 52 is formed by the second video light C2 from the region 402. In the configuration example of FIG. 6, in the effective area of the reflection surface sf5 of the concave mirror M1, the region 401 where the first video light C1 is reflected and the region 402 where the second video light C2 is reflected are separated.

As illustrated in FIG. 5 and others, in the HUD apparatus 1 according to the first embodiment, the component parts for reflecting the two video lights C1 and C2 from the one picture generation unit PGU1 are unified as the one concave mirror M1. The configuration of the regions where the two video lights C1 and C2 are irradiated in the effective area of the reflection surface sf5 of the concave mirror Ml is not limited to the configuration examples illustrated in FIG. 5 and FIG. 6, and modifications thereof will be described later.

### Measures Against Sunlight

The HUD apparatus 1 according to the first embodiment is devised as follows for measures against sunlight. The functions and structures related to the measures against sunlight are constituted by the combination of a polarizing element and an infrared (IR) cut described below.

First, a configuration example of the polarizing element is as follows. In FIG. 3, the dust cover 71 provided at the opening of the housing 60 is made of transparent plastic, and an absorptive polarizing element is provided on the surface of the transparent plastic. This absorptive polarizing element has an absorption axis perpendicular to the video light (first video light C1 and second video light C2).

Further, immediately posterior to the display surface sf1 of the LCD 12 in the picture generation unit PGU1, a reflective polarizing element absorptive polarizing element is provided as an optical element. This reflective polarizing element has a reflection axis perpendicular to the video light (first video light C1 and second video light C2). This absorptive polarizing element has an absorption axis perpendicular to the video light (first video light C1 and second video light C2).

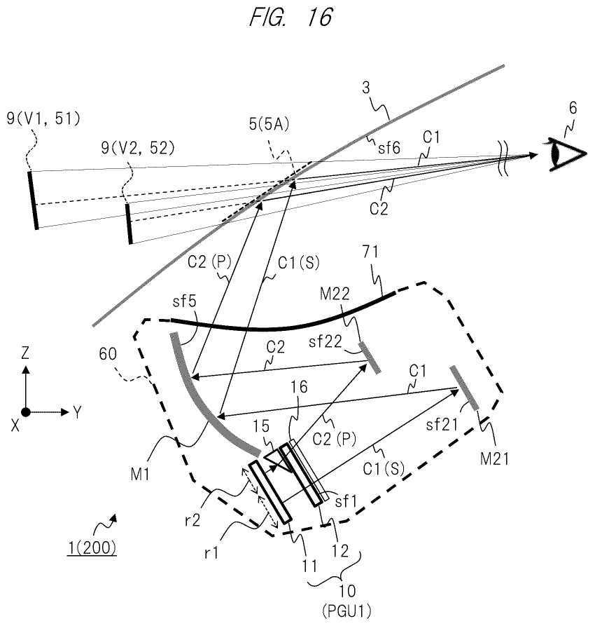

FIG. 16 illustrates a configuration example related to the polarizing element as a modification 1C. In the example of FIG. 16, an absorptive polarizing element is disposed as an optical element 16 immediately posterior to the display surface sf1 of the LCD 12. This absorptive polarizing element absorbs components other than the S-polarized light for the first video light C1 and the second video light C2.

As a modification related to the polarizing element, a polarizing element may be disposed in each of the first region r1 and the second region r2 separately on the display surface sf1 of the LCD 12.

A configuration example related to the IR cut is as follows. First, an IR absorbing function is provided for the dust cover 71. For example, an IR absorbing sheet is provided as one layer of the dust cover 71.

Moreover, the mirrors M21 and M22 are configured as cold mirrors. The cold mirror is a mirror that transmits infrared light and reflects visible light. The visible light reflected by the cold mirror is the first video light C1 and the second video light C2.

In the configuration without measures against sunlight, when external light such as sunlight enters the housing 60 through the dust cover 71 at the opening, the entered external light is reflected by the concave mirror M1, and the reflected external light may enter the display surface sf1 of the picture generation unit PGU1. In this case, in particular, the external light undesirably enters the surface of the LCD 12 serving as the display panel to cause the panel burn. Therefore, in the first embodiment, the above-mentioned functions and structures for the measures against sunlight are provided.

The case where external light such as sunlight passes through the dust cover 71 and enters the housing 60 in the opposite direction to the directions of the video lights C1 and C2 in FIG. 16 will be considered. First, the IR component of the external light is cut off by the IR absorbing function of the dust cover 71. Then, the external light is reflected by the concave mirror M1, and a part of the reflected external light may be further reflected by the mirror M21 and the mirror M22. At this time, the cold mirrors provided as the mirrors M21 and M22 cut off the IR component of the entered external light. A part of the external light reflected by the mirror M21 and the mirror M22 may further travel toward the picture generation unit PGU1 and enter the display surface sf1. At this time, the reflective polarizing element or absorptive polarizing element provided as the optical element 16 disposed on the front surface side of the LCD 12 reflects or absorbs the external light. In this way, the amount of external light that reaches the display surface sf1 of the LCD 12 is reduced. Therefore, it is possible to prevent or reduce the panel burn and the like of the LCD 12.

### Optical Path Blocking Function and Protection Mode

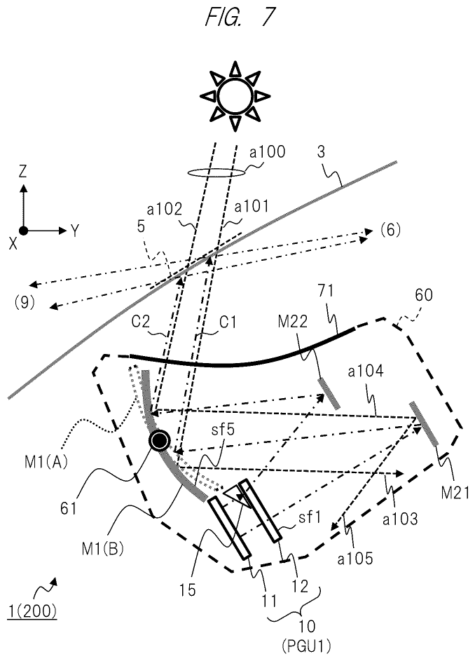

FIG. 7 illustrates a schematic explanatory diagram related to the optical path blocking function (in other words, the external light entrance prevention function) and the protection mode of the video display unit 200 in the HUD apparatus 1 according to the first embodiment on the Y-Z plane like FIG. 3. The HUD apparatus 1 according to the first embodiment further has the optical path blocking function related to the measures against sunlight, based on the configurations of the picture generation unit PGU1 and the mirrors M21, M22, and M1 in FIG. 3. This optical path blocking function is a function of blocking the optical path of entered external light such as sunlight on the optical path from the dust cover 71 to the picture generation unit PGU1 and in particular preventing the external light from entering the display surface sf1 of the LCD 12. This function is the function that shifts the direction of the optical path of external light, in other words, the function that changes the direction of the optical path of external light by rotating the mirror M1 in accordance with the control mode (sometimes referred to as protection mode or the like) such that the external light does not enter the display surface sf1 of picture generation unit PGU1. This function makes it possible to prevent the panel burn and the like of the LCD 12.

In FIG. 7, the concave mirror M1 is provided with a drive mechanism 61 such as a rotating shaft and a motor. The rotating shaft of the drive mechanism 61 extends in the X-axis direction corresponding to the left-right direction of the vehicle, and the concave mirror M1 can be rotated around this rotating shaft by driving the motor or the like connected to the rotating shaft. By rotating the concave mirror M1 using this drive mechanism 61, the orientation of the concave mirror M1 can be changed. In the first embodiment, the mechanism capable of rotating the mirror M1 can be shared with the mechanism for adjusting the formation position of the display region 5 in the up-down direction 5a (FIG. 5 and others).

First, in the normal display mode, the HUD apparatus 1 sets the state of the concave mirror M1 to a state A indicated by the dashed line, and the optical axes of the video lights C1 and C2 for the respective display regions 51 and 52 in this state A are as indicated by the dashed-dotted arrows. The external light entering optical path that is in the opposite direction to the directions of the optical axes of the video lights C1 and C2 in the normal display mode will be considered. External light a100 which is sunlight a100 indicated by a dashed arrow in the drawing represents the optical axis of this external light entering optical path. External light a101 represents the optical path of external light in the opposite direction to the optical path of the first video light C1, and external light a102 represents the optical path of external light in the opposite direction to the optical path of the second video light C2. When the external light a100 (a101, a102) which is sunlight on this external light entering optical path passes through the dust cover 71 and enters the housing 60, it is reflected by the mirror M1 and travels in the opposite direction to the optical paths of the video lights C1 and C2. The external light is reflected by the mirrors M21 and M22, travels toward the picture generation unit PGU1, and enters the display surface sf1. This will affect the panel burn of the LCD 12, and so measures must be taken.

The HUD apparatus 1 according to the first embodiment has a function of switching from a normal display mode to a protection mode as a function for blocking the optical path of external light a100 that enters the picture generation unit PGU1 illustrated in the drawing. In the protection mode, the HUD apparatus 1 according to the first embodiment sets the state of the concave mirror M1 to a state B indicated by the solid line by rotating the mirror M1 based on the drive mechanism 61. The mirror M1 is set from the state A to the state B by being rotated around the rotating shaft by a predetermined angle in the Y-axis direction toward the front side (rear side of the vehicle).

In this way, in the protection mode, the external light a101 and the external light a102 which are sunlight a100 entering the housing 60 through the dust cover 71 are reflected by the mirror M1 in the state B and then travel as external light a103 and external light a104, respectively. The direction of the optical path of the external light a103 based on the external light a101 is shifted so as not to hit the surface sf21 (FIG. 3) of the mirror M21. The direction of the optical path of the external light a104 based on the external light a102 is shifted so as not to hit the surface sf22 (FIG. 3) of the mirror M22.

More specifically, the optical path of the external light a103 is directed toward a position shifted downward in the Z-axis direction with respect to the surface sf21 (FIG. 3) of the mirror M21. This external light a103 is not reflected by the mirror M22 and thus does not enter the display surface sf1 of the picture generation unit PGU1. Further, the optical path of the external light a104 is directed toward a position shifted downward in the Z-axis direction with respect to the surface sf22 (FIG. 3) of the mirror M22. The optical path of this external light a104 hits the surface sf21 (FIG. 3) of the mirror M21 located on the back side and lower side relative to the mirror M22, but the optical path of external light a105 after this external light a104 is reflected by the mirror M21 is directed toward a position shifted downward in the Z-axis direction with respect to the display surface sf1 of the picture generation unit PGU1. Namely, the direction of the optical path of the external light a105 based on the external light a102 is also shifted so as not to hit the display surface sf1 of the picture generation unit PGU1.

As described above, in the protection mode, the HUD apparatus 1 according to the first embodiment is controlled to change the direction of the optical path of reflected external light in accordance with the rotation of the concave mirror M1 such that the external light does not enter the display surface sf1 of the picture generation unit PGU1. In this way, the picture generation unit PGU1, in particular, the panel surface of the LCD 12 is protected from deterioration.

The mechanism for shifting the optical path of external light in accordance with the rotation of the mirror M1, in other words, the mechanism for blocking the external light from entering the picture generation unit PGU1 is not limited to the configuration example illustrated in FIG. 7. Any configuration is possible as long as the directions of the optical paths of the external lights a103 and a104 reflected from the concave mirror M1 are changed such that the external lights do not ultimately enter the display surface sf1 of the picture generation unit PGU1, regardless of whether the external lights are irradiated to the mirror M21 and the mirror M22.

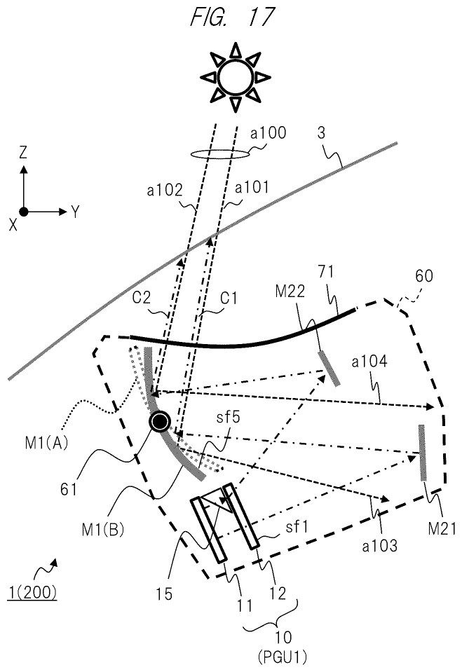

FIG. 17 illustrates a modification 1D related to the optical path blocking function as a modification of the first embodiment. In this modification 1D, the two mirrors M21 and M22 are disposed with a wider interval therebetween in the Z-axis direction as compared with the configuration example of FIG. 7. In accordance with the arrangement of the mirrors M21 and M22, the two video lights C1 and C2 from the display surface sf1 of the picture generation unit PGU1 are designed such that the difference in the angle of their directions becomes larger using the optical element 15. In this modification 1D, when the concave mirror M1 is set to the state B in the protection mode, the directions of the optical paths of the external light a103 and the external light a104 after being reflected by the concave mirror M1 based on the entered external light a100 (a101, a102) are shifted so as not to hit the mirrors M21 and M22, respectively.

Specifically, the direction of the optical path of the external light a103 based on the external light a101 is directed toward a position shifted downward with respect to the mirror M21. The direction of the optical path of the external light a104 based on the external light a102 is directed toward a position shifted downward with respect to the mirror M22, in particular, toward the space between the mirror M22 and the mirror M21. Unlike FIG. 7, the optical path of the external light a104 does not hit even the mirror M21. In this way, in the modification 1D as well, it is possible to prevent the external light from entering the display surface sf1 of the picture generation unit PGU1 in the protection mode.

In addition, in the first embodiment, the direction of rotation of the mirror M1 is set to a direction in which it is tilted from the back side to the front side in the Y-axis direction as illustrated in FIG. 7, whereby the direction of the optical axis of the external light reflected from the concave mirror M1 is shifted downward with respect to each of the mirrors M21 and M22 like the external light a103 and the external light a104. The configuration is not limited to this. In a modification, the direction of rotation of the mirror M1 may be set to a direction in which it is tilted from the front side to the back side, whereby the direction of the optical axis of the external light reflected from the concave mirror M1 may be shifted upward with respect to each of the mirrors M21 and M22. However, this case is not preferable because the reflection surface sf5 of the mirror M1 is directed further upward and there is a possibility that stray light is generated inside the vehicle 2. Therefore, in the first embodiment, the direction of rotation of the mirror M1 is set to a direction in which it is tilted to the front side as described above.

As described above, the HUD apparatus 1 performs the drive control such that the mirror Ml is set to the first state (state A) in the normal display mode and to the second state (state B) in the protection mode. Regarding the control of switching to the protection mode, for example, there are the following two methods. In the first case, the HUD apparatus 1 sets the protection mode when not in use or when the virtual image 9 is not displayed, and sets the normal display mode when the virtual image 9 is displayed. In addition, when an ignition switch of the vehicle 2 is in the OFF state as well, the HUD apparatus 1 sets the protection mode and blocks the external light entering optical path in order to protect the picture generation unit PGU1.

In the second case, even in the normal display mode, the HUD apparatus 1 automatically switches the mode to the protection mode when the entrance of the external light is detected based on the sensor and it is determined that the entrance of the external should be avoided from the viewpoint of temperature as described below. This control is performed when prioritizing the avoidance of entrance of external light and the prevention of panel burn over the display of the virtual image 9.

### Mounting Example

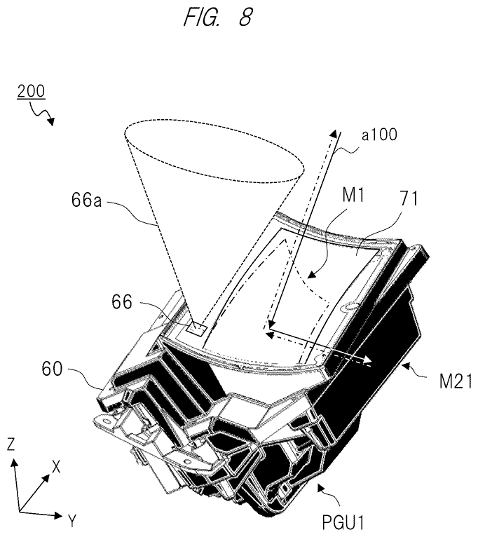

FIG. 8 illustrates a mounting example of the housing 60, the picture generation unit PGU1, the mirror M21, the mirror M1, the dust cover 71, and others in the video display unit 200. In FIG. 8, only the mirror M21 of the two mirrors M21 and M22 is illustrated, and the illustration of the other mirror M22 is omitted.

In addition, in the mounting example in FIG. 8, an insolation sensor 66 is provided near the dust cover 71. The insolation sensor 66 detects the entrance of external light such as the sunlight a100 within a detection range such as a range 66a.

### Temperature Detector and Measures Against Sunlight

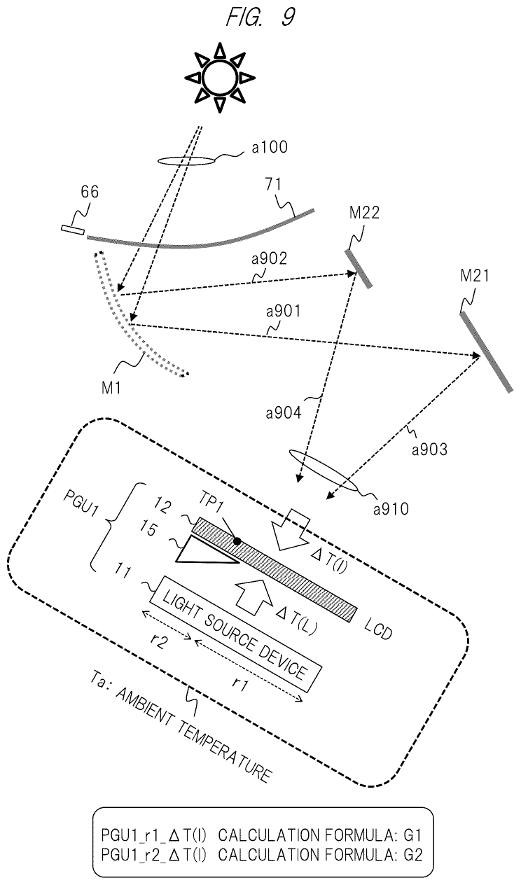

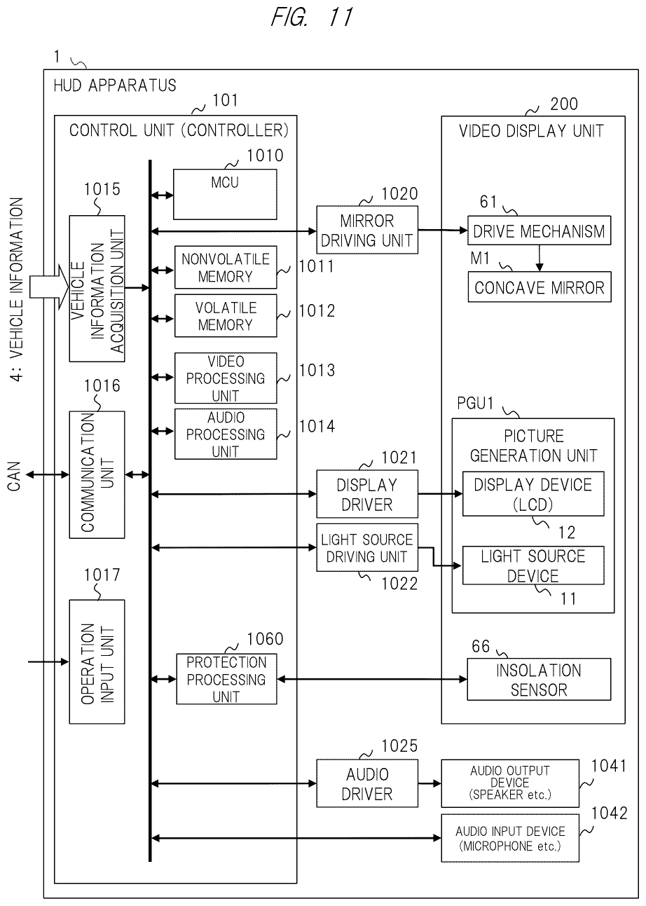

FIG. 9 is a schematic explanatory diagram related to a temperature control using the insolation sensor 66 and others for the optical path blocking function and the protection mode As will be described later (FIG. 11), a control in FIG. 7. section 101 of the HUD apparatus 1 also includes a protection processing unit 1060 that performs temperature detection, protection processing, and the like based on detection information from the insolation sensor 66 in FIG. 8. FIG. 9 illustrates an example of the processing contents by the protection processing unit 1060. FIG. 9 mainly illustrates the picture generation unit PGU1 extracted from FIG. 3, FIG. 7, and others, and illustrates the dust cover 71, the insolation sensor 66, the mirror M1, and others in a simplified manner.

In FIG. 9, the picture generation unit PGU1 is configured to include the light source device 11 and the LCD 12 serving as a display device. In the normal display mode, the external light a100 which is the sunlight a100 is reflected by the concave mirror M1 to be external light a901 and external light a902. The external light a901 is reflected by the mirror M21 to be external light a903, and the external light a902 is reflected by the mirror M22 to be external light a904. The external light a903 and the external light a904 are directed toward the display surface sf1 of the LCD 12 of the picture generation unit PGU1.

First, the temperature (TP1) of the LCD 12 provided in the picture generation unit PGU1 can be estimated from an ambient temperature Ta of the picture generation unit PGU1, a temperature rise amount ΔT(I) caused by the external light a910 (a903, a904) that enters the LCD 12, and a temperature rise amount ΔT(L) caused by heat radiation from the light source device 11.

Simply, the ambient temperature Ta, the temperature rise amount ΔT(I), the temperature rise amount ΔT(L), and others can be assumed to be approximately the same in the first region r1 and the second region r2 of the picture generation unit PGU1, and the temperature TP1 of the LCD 12 in each region can be estimated using a similar mechanism. In detail, the ambient temperature Ta, the temperature rise amount ΔT(I), the temperature rise amount ΔT(L), and others may be assumed to be individually different in the first region r1 and the second region r2 of the picture generation unit PGU1, and the temperature of the LCD 12 in each region may be estimated.

The protection processing unit 1060 of the HUD apparatus 1 in FIG. 11 performs the following process. First, the ambient temperature Ta of the picture generation unit PGU1 can be detected by a temperature sensor installed in the HUD apparatus 1 or a temperature sensor 912 (FIG. 10) installed in the vehicle 2. The protection processing unit 1060 grasps the ambient temperature Ta of the picture generation unit PGU1 based on the detection information of the temperature sensor.

Next, the temperature rise amount ΔT(I) caused by the sunlight a100 can be calculated based on the sunlight intensity detected by the insolation sensor 66. The protection processing unit 1060 calculates the temperature rise amount ΔT(I) of the picture generation unit PGU1 caused by the external light a 910 based on the detection information of the insolation sensor 66.

Next, the temperature rise amount ΔT(L) caused by the heat radiation from the light source device 11 can be calculated based on the brightness or light amount of the backlight set in the light source device 11, for example, the duty ratio of the pulse width modulation (PWM) control by a light source driving unit 1022. The protection processing unit 1060 calculates the temperature rise amount ΔT(L) caused by heat radiation from the light source device 11 of the picture generation unit PGU1.

In the control example of the first embodiment, the calculation formula for calculating the temperature rise amount ΔT(I) on the side of the LCD 12 is set individually in accordance with the difference between the first region r1 and the second region r2. The respective calculation formulas are illustrated as calculation formulas G1 and G2. As a modification, in a simplified configuration, the same calculation formula may be used to calculate the temperature rise amount ΔT(I) in the first region r1 and the second region r2 of the picture generation unit PGU1.

As described above, the protection processing unit 1060 indirectly detects the temperature TP1 of the display surface of LCD 12 by the calculation using the ambient temperature Ta of the picture generation unit PGU1, the temperature rise amount ΔT(I) of the LCD 12 due to sunlight, and the temperature rise amount ΔT(L) from the light source device 11.

Here, the temperature rise amount ΔT(L) caused by the heat radiation from the light source device 11 is a parameter that can be controlled by the brightness or light amount of the backlight. In other words, there is a predetermined relationship between the brightness or light amount of the backlight of the light source device 11 and the temperature of the LCD 12, and it can be said that the temperature of the LCD 12 can be adjusted by adjusting the brightness or light amount of the backlight of the light source device 11.

Therefore, the control section 101 of the HUD apparatus 1 performs control so as to adjust the brightness or light amount of the backlight of the light source device 11 in accordance with the temperature TP1 of the LCD 12 detected by the protection processing unit 1060. For example, the control section 101 compares the detected temperature TP1 of the LCD 12 with a preset predetermined threshold value, and adjusts the brightness or light amount of the backlight of the light source device 11 when the detected temperature TP1 exceeds the threshold value. For example, when the detected temperature TP1 exceeds a set threshold value Th1, the control section 101 performs the drive control to reduce the brightness or light amount of the backlight of the light source device 11, that is, reduce the duty ratio of the PWM control. In this way, it is possible to suppress the temperature rise of the LCD 12 in the picture generation unit PGU1.

### Vehicle Information and Sensors

FIG. 10 illustrates a configuration example of sensors and others that a vehicle information acquisition unit 1015 (FIG. 11) of the HUD apparatus 1 or the control unit 100 of the vehicle 2 uses to acquire the vehicle information 4 in FIG. 1. FIG. 10 illustrates examples of various sensors, in other words, information acquisition devices, measurement devices, communication devices, and the like connected to the vehicle information acquisition unit 1015 or the control unit 100. For example, the control unit 100 acquires the vehicle information 4 from the sensors and the like installed in various parts of the vehicle 2. The various sensors detect parameter values related to conditions such as driving conditions inside and outside the vehicle 2, for example, periodically. In addition, the control unit 100 judges and detects various events related to the vehicle 2 based on the detection information of the sensors.

The vehicle information 4 is a general term for information related to the driving conditions of the vehicle 2 and others. The vehicle information 4 includes ADAS information and the like. The vehicle information 4 includes, for example, speed information and gear information of the vehicle 2, steering wheel angle information, lamp lighting information, external light information, distance information, infrared information, engine ON/OFF information, camera video information, acceleration gyro information, GPS (Global Positioning System) information, navigation information, vehicle-to-vehicle communication information, road-to-vehicle communication information, and others. The camera video information includes vehicle interior camera video information and vehicle exterior camera video information. The GPS information includes current time information and latitude and longitude information.

In FIG. 10, the various sensors include a vehicle speed sensor 901, a shift position sensor 902, a steering wheel angle sensor 903, a headlight sensor 904, an illuminance sensor 905, a chromaticity sensor 906, a distance sensor 907, an infrared sensor 908, an engine start sensor 909, an acceleration sensor 910, a gyro sensor 911, a temperature sensor 912, a road-to-vehicle communication wireless transceiver 913, a vehicle-to-vehicle communication wireless transceiver 914, a vehicle interior camera 915, a vehicle exterior camera 916, a GPS receiver 917, a VICS (Vehicle Information and Communication System, registered trademark) receiver 918, and others. The various sensors are not limited to those, and may be added, deleted, replaced, and others.

The vehicle speed sensor 901 detects the speed of the vehicle 2 (referred to also as vehicle speed) and generates speed information representing the detection result. The shift position sensor 902 detects the current gear and generates gear information representing the detection result. The steering wheel angle sensor 903 detects the current steering wheel angle and generates steering wheel angle information representing the detection result. The headlight sensor 904 detects whether the headlights are on or off and generates lamp lighting information representing the detection result. The illuminance sensor 905 and the chromaticity sensor 906 detect external light and generate external light information representing the detection result.

The distance sensor 907 detects the distance between the vehicle 2 and an external object and generates distance information representing the detection result. The infrared sensor 908 detects the presence or absence of an object in the vicinity of the vehicle 2 as well as the distance thereto and generates infrared information representing the detection result. The engine start sensor 909 detects whether the engine is on or off and generates ON/OFF information representing the detection result. The acceleration sensor 910 and the gyro sensor detect the acceleration and angular velocity of the vehicle 2 and generate acceleration gyro information representing the attitude and behavior of the vehicle 2 as the detection result. The temperature sensor 912 detects the temperature inside and outside the vehicle 2 and generates temperature information representing the detection result.

The vehicle interior camera 915 captures images inside the vehicle 2 and generates vehicle interior camera video information. The vehicle exterior camera 916 captures images outside the vehicle 2 and generates vehicle exterior camera video information. In a specific example, the camera 90 in FIG. 2 corresponds to the vehicle interior camera 915 and the vehicle exterior camera 916. The vehicle interior camera 915 captures, for example, the driver's posture, eye position, and movement, and constitutes a Driver Monitoring System (DMS). By analyzing the vehicle interior camera video information, it is possible to grasp the driver's fatigue degree and line of sight. In addition, the vehicle exterior camera 916 captures images of the surrounding conditions, for example, the area in front of the vehicle 2. By analyzing the vehicle exterior camera video information, it is possible to grasp the presence or absence of other vehicles or people around the vehicle 2, buildings and topography, road conditions such as rain, snow, ice, and undulations, road signs, and the like. In addition, the vehicle exterior camera 916 includes, for example, a drive recorder configured to record a video of the driving situation.

The road-to-vehicle communication wireless transceiver 913 generates road-to-vehicle communication information through the road-to-vehicle communication between the vehicle 2 and roads, signs, traffic lights, and others. The vehicle-to-vehicle communication wireless transceiver 914 generates vehicle-to-vehicle communication information through the vehicle-to-vehicle communication between the vehicle 2 and other vehicles in the vicinity. The GPS receiver 917 generates GPS information by receiving GPS signals from GPS satellites. For example, the current time, latitude, and longitude can be acquired as the GPS information. The VICS receiver 918 generates VICS information acquired by receiving VICS signals. The GPS receiver 917 and the VICS receiver 918 may be provided as a part of a navigation system.

### Functional Blocks

FIG. 11 illustrates a configuration example of the functional blocks of the HUD apparatus 1. In the configuration example of FIG. 11, a display driver 1021, a light source driving unit 1022, and the like are provided so as to correspond to the configuration of the picture generation unit PGU1 and the concave mirror M1 in FIG. 3 described above. In this configuration example, a video processing unit 1013 which is connected to the display driver 1021 and the light source driving unit 1022 is provided.

In FIG. 11, the HUD apparatus 1 includes the control section 101, the video display unit 200, a mirror driving unit 1020, the display driver 1021, the light source driving unit 1022, an audio driver 1025, an audio output device 1041, an audio input device 1042, and the like. The control section 101 includes an MCU (micro control unit) 1010, a non-volatile memory 1011, a volatile memory 1012, the video processing unit 1013, an audio processing unit 1014, the vehicle information acquisition unit 1015, a communication unit 1016, an operation input unit 1017, the protection processing unit 1060, and others. These units are mutually connected through a bus or the like, and mutual input/output and communication are possible.

The control section 101 is, in other words, a controller or a control device. The control section 101 realizes control functions and the like based on processing by a processor. The control function is a function for controlling the entire HUD apparatus 1 and each part thereof, and includes a function for displaying the virtual image 9 in the display region 5. The control section 101 realizes its functions by software program processing or a dedicated circuit.

A storage unit of the HUD apparatus 1 is configured to include the non-volatile memory 1011 and the volatile memory 1012. The storage unit stores various types of data and information including computer programs handled by the control section 101 and the like.

The communication unit 103 is a device mounted with a communication interface. The communication unit 103 is connected to the control unit 100 (for example, electronic control unit: ECU) so as to be communicable with it via an interface such as a Controller Area Network (CAN) or a Local Interconnect Network (LIN) of the vehicle 2 as a communication interface.

The mirror driving unit 1020 is a device that drives the drive mechanism 61 of the concave mirror M1 based on the control from the control section 101.

The display driver 1021 is a device including a driving circuit and the like for driving the LCD 12 of the picture generation unit PGU1 based on the control from the control section 101.

The light source driving unit 1022 is a device including a driving circuit and the like for driving the light source device 11 of the picture generation unit PGU1 based on the control from the control section 101. The light source driving unit 1022 includes a driving circuit and the like capable of turning on/off the light emission and changing the light amount of each light source element of the light source device 11.

The audio input device 1042 is made up of a microphone, a circuit, and the like. The audio output device 1041 is made up of a speaker, a circuit, and the like. Although the case where the HUD apparatus 1 is provided with the audio input device 1042 and the audio output device 1041 is illustrated here, the HUD apparatus 1 is not limited thereto, and the HUD apparatus 1 may also utilize the audio input device 1042 and the audio output device 1041 externally connected to the vehicle 2 (for example, control unit 100).

The control section 101 in FIG. 11 acquires input information such as the vehicle information 4 (FIG. 1), ADAS information, and event information through the vehicle information acquisition unit 1015. In addition, the control section 101 acquires input information such as the vehicle information 4 (FIG. 1), ADAS information, and event information from the control unit 100 through the communication unit 103 as the CAN signal. The vehicle information acquisition unit 1015 may be mounted integrally with the communication unit 103. The input information includes detection signals from the various sensors illustrated in FIG. 10, information about the results of processing the detection signals by the control unit 100, and the like. The input information includes, for example, information about objects in the actual scenery detected based on the images from the camera 90 and alert information and navigation information to be superimposed on the objects. The control section 101 generates video data and video information for displaying the virtual image 9 in the display region 5 by the control function as necessary based on such input information. The control section 101 generates the video signal for controlling the display driver 1021 and the like based on the video data and video information.

Also, the control section 101 may acquire the operation input information by the user through the operation input unit 1017. Examples of the operation input unit 1017 include a remote controller and the like. Further, when audio output by the HUD apparatus 1 is performed, the control section 101 generates audio output information to control the audio driver 1025. Furthermore, when receiving audio input from a user such as a driver, the control section 101 performs audio recognition based on the input audio from the audio input device 1042, thereby accepting predetermined instructions and the like.

The HUD apparatus 1 is not limited to the configuration example of FIG. 11, and may include various sensors and others including, for example, the insolation sensor 66 (FIG. 8). The control section 101 may perform predetermined control by judging and detecting the state of the HUD apparatus 1 and the state in the vicinity of the HUD apparatus 1 using the detection information from the sensors.

Note that components such as the control section 101 in FIG. 11 may be mounted in the housing 60 of the video display unit 200 in FIG. 3 and others or may be connected to the outside of the housing 60.

### Example of Video Display Control

An example of video display control by the control section 101 in FIG. 11 is as follows. The control section 101 generates video data for displaying the virtual image 9 in the display region 5 based on input information such as the vehicle information 4 and the input video data. For example, the HUD apparatus 1 determines to display the AR navigation image or alert image as the first virtual image V1 in the first display region 51 and display the non-AR distance information, vehicle speed information, or the like as the second virtual image V2 in the second display region 52. For this purpose, the control section 101 generates first video data whose output destination is the first region r1 of the LCD 12 of the picture generation unit PGU1 and second video data whose output destination is the second region r2.

The control section 101 performs the distortion correction taking into account the difference in the curvature of the windshield 3 and the adjustment of the on/off and light amount of the light source, based on the video data of the display source. The control section 101 performs the drive control of the display driver 1021 and the light source driving unit 1022 based on the video data. The display driver 1021 drives the LCD 12 based on the signal from the control section 101. The light source driving unit 1022 drives the light source device 11 based on the signal from the control section 101. In this way, videos are formed in the first region r1 and the second region r2 on the display surface sf1 of the LCD 12, respectively. The picture generation unit PGU1 emits the first video light C1 based on the source light from the light source device 11 and the video formed in the first region r1 of the LCD 12, and emits the second video light C2 based on the source light from the light source device 11 and the video formed in the second region r2 of the LCD 12.

Further, the protection processing unit 106 of the control section 101 in FIG. 11 performs processing corresponding to the control of switching between the normal display mode and the protection mode based on the detection information of the insolation sensor 66 as described above.

### Configuration Example of Picture Generation Unit

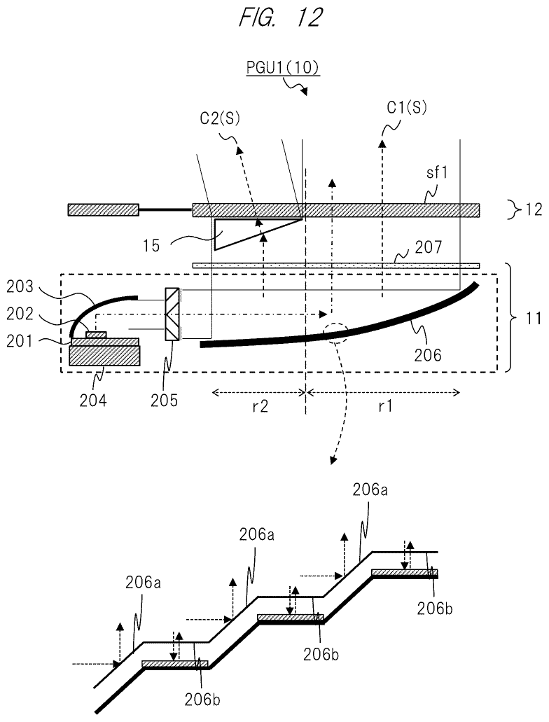

A mounting configuration example of the picture generation unit PGU1 which is the video display device 10 is as follows. FIG. 12 illustrates the mounting configuration example of the picture generation unit PGU1. The picture generation unit PGU1 in FIG. 12 includes the light source device 11 and the LCD 12. The light source device 11 is made up of an LED board 201, an LED element 202, a reflector 203, a heat sink 204, a polarization conversion element 205, a light guide 206, a diffusion plate 206, and the like. The light source device 11 is configured as a light source module with these components fixed in a case.

A plurality of LED elements 202 is arranged on the LED board 201. In FIG. 12, only one LED element 202 and one reflector 203 are illustrated. The LED element 202 is an example of a semiconductor light source element. The reflector 203 is a collimator configured to reflect the diffusion light emitted from the LED element 202 so as to change the direction of the light, thereby converting the light into substantially parallel light. The heat sink 204 dissipates heat and cools the LED board 201.

The polarization conversion element 205 receives the substantially parallel light from the reflector 203, performs polarization conversion to align the polarization characteristics, and emits the substantially parallel light after polarization conversion to the light guide 206. The polarization conversion element 205 is configured by combining, for example, a polarization conversion prism and a wave plate. In the first embodiment, the polarization conversion in the polarization conversion element 205 in the picture generation unit PGU1 is a polarization conversion for aligning the light into polarization perpendicular to an absorption axis of the polarizing plate on the incidence side of the LCD 12.

The light guide 206 receives the substantially parallel light in a first direction from the polarization conversion element 205 at a reflection portion to reflect it in a second direction. The second direction is the direction toward the LCD 12. As illustrated in the partially enlarged view, the reflection portion of the light guide 206 has a plurality of reflection surfaces 206a and a plurality of connecting surfaces 206b, and the reflection surfaces 206a and the connecting surfaces 206b are arranged alternately. The reflection portion of the light guide 206 also provides a predetermined light distribution control. The plurality of reflection surfaces 206a has respective inclinations so as to realize the reflection direction corresponding to a predetermined light distribution control.

The light in the second direction after being reflected by the reflection portion of the light guide 206 enters the diffusion plate 207 and is diffused by the diffusion plate 207. On the upper side relative to the diffusion plate 207, the panel of the LCD 12 is disposed via a space including the optical element 15 described above. A driving circuit board and the like are connected to the panel of the LCD 12 via a flexible cable. The panel of the LCD 12 receives the light from the diffusion plate 207 from the back side, and emits the video lights C1 and C2 from the display surface sf1 on the front side using the light as backlight. In the first region r1 described above, the first video light C1 is generated based on the source light that does not pass through the optical element 15. In the second region r2 described above, the second video light C2 is generated based on the source light that passes through the optical element 15. These video lights C1 and C2 are light flux having the above-mentioned S-polarized light directivity in a specific direction.

### Effects of First Embodiment

As described above, with the HUD apparatus 1 according to the first embodiment, the two display regions 5 (51, 52) in which the virtual images 9 can be displayed, in particular, a layered display area can be favorably formed. As a result, the HUD apparatus 1 can provide the driver U1 with various virtual images 9 for driving assistance and the like using the two display regions 5 (51, 52), thereby contributing to safe driving.

### Second Embodiment

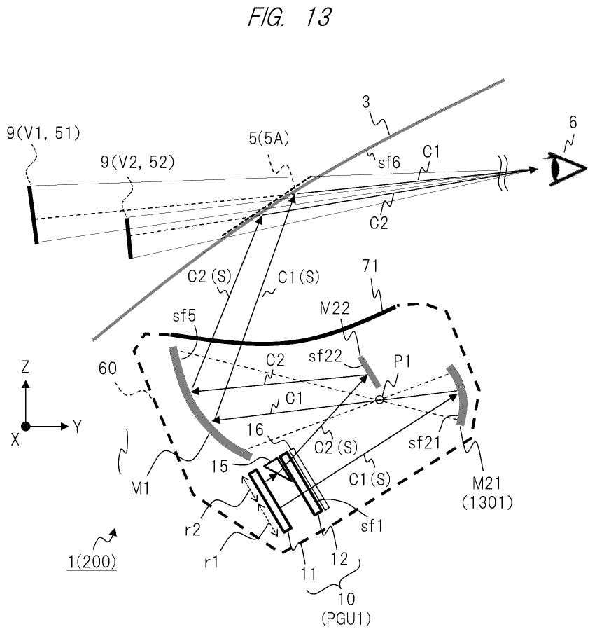

A HUD apparatus according to the second embodiment will be described with reference to FIG. 13 and subsequent drawings. In the following, the configurations of the second embodiment different from those of the first embodiment will be mainly described. In the second embodiment, the mirror M21 on the lower side in the Z-axis direction of the two mirrors M21 and M22 described above is composed of a concave mirror 1301. The first video light C1 reflected by this concave mirror 1301 is first collected at a predetermined point P1, and then enters the concave mirror M1. The point P1 of the light collecting position of the mirror M21 is located near the mirror M22. In a specific example, the point P1 is at a predetermined position on the lower side relative to the mirror M22 in the Z-axis direction. With the optical system that collects the light using the concave mirror 1301 in this manner, the picture generation unit PGU1 and the mirror M21 can be disposed closer to the concave mirror M1 and the mirror M22. With this configuration, the HUD apparatus 1 according to the second embodiment can further reduce the size of the video display unit 200.

In the second embodiment, since the optical system is configured to collect the light by the concave mirror 1301 on the optical path of the first video light C1 as described above, the image depicted in the first region r1 and the image depicted in the second region r2 on the display surface sf1 of the LCD 12 serving as the video source are inverted relative to each other in the up-down direction. The first video light C1 from the first region r1 is reflected by the concave mirror 1301 to become the video light C1 inverted in the up-down direction, and then enters the concave mirror M1. The second video light C2 from the second region r2 that passes through the optical element 15 is reflected by the mirror M22 which is a plane mirror, and then enters the concave mirror M1 similarly to the first embodiment. As in the first embodiment, the virtual images 9 (V1, V2) of the two display regions 5 (51, 52) are formed for the windshield 3 by the respective video lights C1 and C2 reflected from the concave mirror M1. The virtual image V1 of the first display region 51 and the virtual image V2 of the second display region 52 are aligned in the up-down direction when viewed from the driver's viewpoint 6.

Measures against Sunlight

The configuration for the measures against sunlight in the HUD apparatus 1 according to the second embodiment is as follows. This configuration is the same and common with the configuration for the measures against sunlight in the above-described first embodiment, and is configured by the combination of a polarizing element and an IR cut described below.

First, a configuration example of the polarizing element is as follows. In FIG. 13, the dust cover 71 provided at the opening of the video display unit 200 is made of transparent plastic, and an absorptive polarizing element is provided on the surface of the transparent plastic. This absorptive polarizing element has an absorption axis perpendicular to the video light (first video light C1 and second video light C2).

Further, immediately posterior to the display surface sf1 of the LCD 12 in the picture generation unit PGU1, a reflective polarizing element or an absorptive polarizing element is provided as an optical element. This reflective polarizing element has a reflection axis perpendicular to the video light (first video light C1 and second video light C2). This absorptive polarizing element has an absorption axis perpendicular to the video light (first video light C1 and second video light C2).

FIG. 13 also illustrates a configuration example related to the polarizing element. In this example, an absorptive polarizing element is disposed as the optical element 16 immediately posterior to the display surface sf1 of the LCD 12. This absorptive polarizing element absorbs components other than the S-polarized light for the first video light C1 and the second video light C2.

As a modification related to the polarizing element, a polarizing element may be disposed in each of the first region r1 and the second region r2 separately on the display surface sf1 of the LCD 12.

A configuration example related to the IR cut is as follows. First, the dust cover 71 is provided with an IR absorbing function. For example, an IR absorbing sheet is provided as one layer of the dust cover 71. Moreover, the mirror M21 which is the concave mirror 1301 and the mirror M22 are configured as cold mirrors.

The case where external light such as sunlight passes through the dust cover 71 and enters the housing 60 in the opposite direction to the directions of the video lights C1 and C2 in FIG. 13 will be considered. First, the IR component of the external light is cut off by the IR absorbing function of the dust cover 71. Then, the external light is reflected by the concave mirror M1, and a part of the reflected external light may be further reflected by the mirror M21 and the mirror M22. At this time, the cold mirrors provided as the mirrors M21 and M22 cut off the IR component of the entered external light. A part of the external light reflected by the mirror M21 and the mirror M22 may further travel toward the picture generation unit PGU1 and enter the display surface sf1. At this time, the optical element 16 on the front surface side of the LCD 12 reflects or absorbs the external light. In this way, the amount of external light that reaches the display surface sf1 of the LCD 12 is reduced. Therefore, it is possible to prevent or reduce the panel burn and the like of the LCD 12.

As a modification of the second embodiment, in the first video light C1 and the second video light C2 from the picture generation unit PGU1, the characteristics of S-polarized light and P-polarized light may be reversed.

### Effects of Second Embodiment

As described above, with the HUD apparatus 1 according to the second embodiment, in addition to the effect of being able to favorably form the two display regions 5 (51, 52) similarly to the first embodiment, it is possible to further reduce the size of the video display unit 200.

### Relationship Between Effective Area of Concave Mirror and Display Region

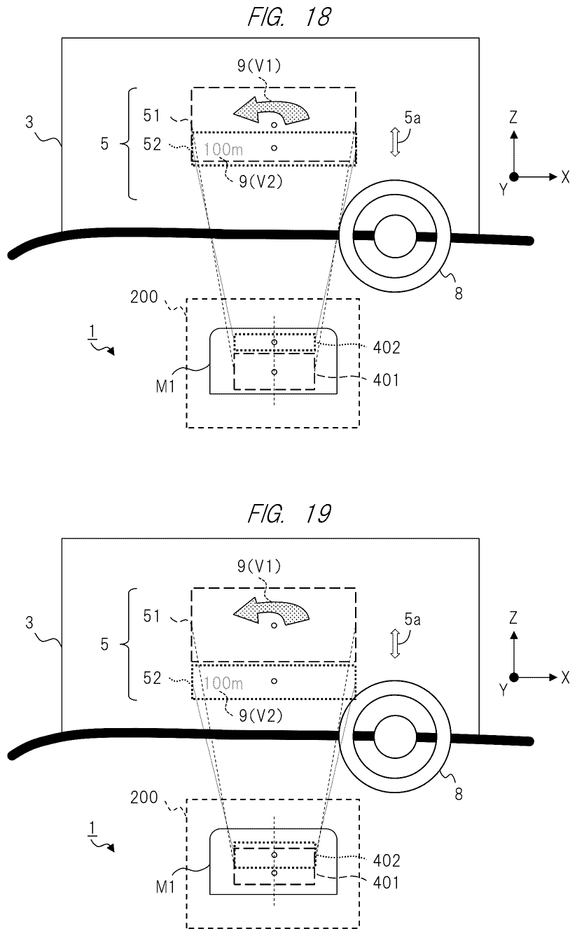

In the first embodiment and others, various configurations are possible regarding the relationship between the effective area on the reflection surface sf5 of the concave mirror M1 onto which the two video lights C1 and C2 are irradiated and the positions where the two display regions 5 (51, 52) are formed, and thus a supplementary description will be provided below. Although two configuration examples are illustrated in the above-mentioned FIG. 5 and FIG. 6, configurations other than these are also possible. Modifications are illustrated in FIG. 18 and FIG. 19. FIG. 18 illustrates a third configuration example, and FIG. 19 illustrates a fourth configuration example.

In the third configuration example of FIG. 18, two effective areas by the two video lights C1 and C2 are formed separately as regions 401 and 402 in the concave mirror M1. In contrast, in accordance with the detailed design of the optical system and the like, the two display regions 5 (51, 52) are formed to overlap each other when viewed from the viewpoint 6. The detailed design of the optical system includes the design of and orientation of the picture the arrangement position generation unit, the design of the shapes of the mirrors M21, M22, and M1 and the reflection direction of each video light, and others.

In the fourth configuration example of FIG. 19, two effective areas by the two video lights C1 and C2 are formed as regions 401 and 402 so as to overlap each other in the concave mirror M1. In contrast, in accordance with the detailed design of the optical system and the like, the two display regions 5 (51, 52) are formed separately when viewed from the viewpoint 6.

In the foregoing, the present invention has been specifically described based on the embodiments, but the present invention is not limited to the embodiments described above and can be modified in various ways within the range not departing from the gist thereof. In each embodiment, components can be added, deleted, or replaced except for essential components. Unless otherwise specified, each component may be singular or plural. A combination of the respective embodiments is also possible.

When the technique related to the embodiment is used, as described above, the effective area of the display panel corresponding to the video light from the light source device is divided into the first region and the second region, and the virtual image of the first display region is formed by the first video light from the first region and the virtual image of the second display region is formed by the second video light from the second region. By providing the technique capable of forming two virtual images corresponding to two display regions on a front side relative to the windshield when viewed from the driver's viewpoint, it is possible to provide the information display apparatus (head-up display apparatus) capable of providing the driver with various virtual images for driving assistance and others and contributing to safe driving and others. This makes it possible to prevent traffic accidents. Furthermore, it is possible to contribute to “Goal 3: Ensure healthy lives and promote well-being for all at all ages” in the Sustainable Development Goals (SDGs) advocated by the United Nations.

### REFERENCE SIGNS LIST

1 HUD apparatus
2 vehicle
3 windshield
4 vehicle information
5, 51, 52 display region (display area)
6 viewpoint
7 opening
8 steering wheel
9, V1, V2 virtual image
10 video display device
15 optical element
60 housing
71 dust cover
200 video display unit or video display
PGU1 picture generation unit or image forming unit
M1, M21, M22 mirror
C1, C2 video light
r1 first region
r2 second region

1. A head-up display apparatus comprising:
an image forming unit configured to emit video light;
an optical element provided in the image forming unit and configured to generate video light divided into a first video light and a second video light as the video light;
a first returning mirror configured to reflect the first video light;
a second returning mirror configured to reflect the second video light; and
a video projector configured to reflect the first video light from the first returning mirror and the second video light from the second returning mirror,
wherein a first display region which is a first display area capable of displaying a first virtual image is formed based on the first video light from the video projector, and
wherein a second display region which is a second display area capable of displaying a second virtual image is formed based on the second video light from the video projector.

2. The head-up display apparatus according to claim 1,
wherein the image forming unit includes a light source device and a display panel configured to generate the video light based on source light from the light source device,
wherein a display surface of the display panel is divided into a first region and a second region and the optical element is disposed so as to correspond to the second region on a back surface side or a front surface side of the display panel, and
wherein the first video light is emitted from the first region and the second video light is emitted from the second region.

3. The head-up display apparatus according to claim 1,
wherein the first display region and the second display region are formed on a front side relative to a transparent member when viewed from a viewpoint of a driver of a vehicle so as to be separated from each other or overlap each other in an up-down direction.

4. The head-up display apparatus according to claim 1,
wherein the first display region and the second display region are formed on a front side relative to a transparent member when viewed from a viewpoint of a driver of a vehicle such that the first display region is disposed relatively farther than the second display region in a front-rear direction.

5. The head-up display apparatus according to claim 1,
wherein the video projector is composed of a mirror, and a region where the first video light is irradiated and a region where the second video light is irradiated are separated from each other or overlap each other on a reflection surface.

6. The head-up display apparatus according to claim 1,
wherein the video projector is composed of a mirror and has a drive mechanism configured to rotate the mirror around a rotating shaft extending in a lateral direction, and
wherein the mirror is rotated in a protection mode with respect to a normal display mode, and when external light enters the mirror in an opposite direction to a direction of the video light, directions of the external light from the mirror to the first returning mirror and the second returning mirror are changed such that the external light reflected by the mirror does not enter a display surface of the image forming unit.

7. The head-up display apparatus according to claim 6, further comprising an insolation sensor or a temperature sensor,
wherein, when entrance of the external light is detected based on detection information of the insolation sensor or the temperature sensor, the normal display mode is switched to the protection mode.

8. The head-up display apparatus according to claim 1,
wherein the first returning mirror is composed of a concave mirror,
wherein the second returning mirror is composed of a plane mirror, and
wherein the first video light enters the video projector after being reflected by the concave mirror and collected at a predetermined light collecting position.

9. The head-up display apparatus according to claim 1,
wherein the image forming unit includes a light source device and a display panel configured to generate the video light based on source light from the light source device, and wherein a reflective polarizing element or an absorptive polarizing element is disposed on a front surface side of the display panel of the image forming unit.
